(19) United States
(12) Patent Application Publication
(10) Pub. No.: US 2008/0211121 A1
(43) Pub. Date: Sep. 4, 2008

(54) Device for manufacturing fabrils and method thereof

(75) Inventors: Horng-Ji Lai, Taipei City (TW); Chien-Cheng Lin, Taipei City (TW); Shang-Ming Lin, Taichung County (TW)

Correspondence Address: BACON & THOMAS, PLLC, 625 SLATERS LANE, FOURTH FLOOR, ALEXANDRIA, VA, 22314, US

(73) Assignee: BODY ORGAN BIOMEDICAL CORP., Taipei City (TW)

(21) Appl. No.: 12/003,236

(22) Filed: Dec. 21, 2007

Related U.S. Application Data
(60) Provisional application No. 60/876,520, filed on Dec. 22, 2006.

(51) Int. Cl. B29B 9/06; B29C 67/00; B29C 31/02; B29C 35/08

(52) U.S. Cl. 264/8; 425/72.2; 425/8; 425/174.4; 264/10; 264/13; 264/477

(57) ABSTRACT

The present invention discloses a device for manufacturing fibrils comprising: a rotating device with at least one opening being made of an electric conduction material and hollow for containing polymer or biopolymer; and an outer barrier being made of electric conduction materials and around the rotating device; wherein while revolving the rotating device results in that the polymer or biopolymer is out of the rotating device through the opening so as to gain the fibrils in between the rotating device and the outer barrier.

The applicant claim the benefit of the filing date of provisional application No. 60/876,520 filed on Dec. 22, 2006 under 35 USC & 119(e) (1).

### BACKGROUND OF THE INVENTION

1. Field of the Invention

The present invention generally relates to a device for manufacturing fibrils and a method thereof, more particularly to a device and method being capable of continuously mass producing fibrils.

2. Description of the Prior Art

Macromolecule materials have been made to thin films or laminated products for a while, but the mechanical properties of the thin films or laminated products are worse than the products made by metal or ceramic materials. Even the densities of macromolecule materials are lower, and such characteristic is helpful to promote specific strength. If spinning macromolecule materials to fibers, which highly have orientation, the mechanical properties will be significantly promoted so as to enhance the axial strength thereof, even competing with carbon fibers, for example, Kevlar (poly-p-phenylene terephthalamide) and PBO (polybenzoxazole). Thus, the density of macromolecule fiber is lower and about 1 g/cm3, Kevlar and PBO are the best candidates to flak vest as well.

Due to the limitations of melt fracture and draw resonance for forming fibers, the spinning ways in prior arts may not produce that the diameter of a fiber is smaller than 100 μm. Nowadays, one of the related arts, called electrospinning, is capable of manufacturing such specific products, and it is described in detail as below.

With reference to FIG. 1, which illustrates a schematic view of a device manufacturing smaller fibers in prior arts. The device 1′ includes a syringe pump 11′, a syringe 12′, a needle 14′, a high voltage supply 15′, and a grounded collector 18′; wherein the syringe pump 11′ lets polymer solution 13′ inside the syringe 12′ be out of the syringe 12′ so as to form jet 17′, which is sprayed by the needle 14′, and the needle 14′ is applied a voltage range of 1-30 kV by the high voltage supply 15′, continuously the jet 17′ is splayed to form a Taylor Cone 19′ with fibers due to applying high voltages, in other words, the Taylor Cone 19′ is formed in an electric field between the needle 14′ and the collector 18′, then the splayed fibers are down to the collector 18′. A high speed camera 16′ is to record the whole procedures of spraying the jet 17′, splaying the jet 17′ to form the Taylor Cone 19′ and gaining fibers on the collector 18′. And the pictures are shown in FIGS. 2A, 2B, 2C, and 2D.

With references to FIGS. 2A, 2B, 2C, and 2D, which illustrate a picture of spraying the jet and splaying the jet to form the Taylor Cone, an amplified picture of the Taylor Cone, a picture of a fiber film with a diameter of 8 cm, and an SEM image of the formed fibers. Therefore, the collected fibers will be micrometer or nanometer.

According to the electrospinning introduced above, there are some factors that should be considered, such as solution viscosity, solution surface tension, solution conductivity, electric field intensity, rheology, morphology, electricity, surface phenomena, etc., and even though the structure of the electrospinning device is very simple. More particularly, the current electrospinning may have following disadvantages:
1. such syringe contains only a little chemical solution, a continuity for manufacturing fibers is lacked, so that mass production cannot be made;
2. the jet may be interrupted by any possibility, which could be one of the factors as aforesaid.

Therefore, how to figure out the disadvantages of prior arts is an important issue to the skilled people in the related field.

### SUMMARY OF THE INVENTION

The primary objective of the present invention is to provide a device and method for manufacturing fibrils, that is, the device features the characteristics of space saving, continuous processes, flexibility, strength, and the toughness of linear, 2-D and 3-D textile structure in order to be applied in a variety of ways and overcome prior arts. On the other hand, due to the unique device, the sprayed jet produced in the prior art will not be interrupted.

The second objective of the present invention is to provide a device and method so as to enhance the properties of cell adhesion, cell proliferation and directional growth, which are made from matrices comprising biocompatible fibers. Accordingly the fibers with small diameters, referred to herein as fibrils, are produced and with adequate strength for textile procedures; on the other hand, the device applied to tissue engineering can be used to scaffolds or matrices, which comprises non-woven fibrils.

A device for manufacturing fibrils comprises: a rotating device with at least one opening being made of an electric conduction material and hollow for containing polymer or biopolymer; and an outer barrier being made of electric conduction materials and around the rotating device; wherein while revolving the rotating device results in that the polymer or biopolymer is out of the rotating device through the opening so as to gain the fibrils in between the rotating device and the outer barrier.

A device for manufacturing fibrils comprises: a rotating device with at least one opening being made of an electric conduction material and hollow for containing polymer or biopolymer; an outer barrier being made of electric conduction materials and around the rotating device; and a high voltage supply; wherein while revolving the rotating device and electrical field being generated between the rotating device and the outer barrier by the high voltage supply result in that the polymer or biopolymer is out of the rotating device through the opening so as to gain the fibrils in between the rotating device and the outer barrier.

A device for manufacturing fibrils comprises: a central device being made of an electric conduction material; and an outer device with at least one opening being made of an electric conduction material and hollow for containing polymer or biopolymer, which includes ferromagnetic substance, the outer device being around the central device; wherein the polymer or biopolymer can be out of the outer device through the opening by magnetic forces between the central device and the polymer or biopolymer with the ferromagnetic substance so as to gain the fibrils in between the central device and the outer device.

A device for manufacturing fibrils comprises: a central device being made of an electric conduction material; an outer device with at least one opening being made of an electric conduction material and hollow for containing polymer or biopolymer, the outer device being around the central device; and a high voltage supply; wherein electrical field being generated between the central device and the outer device by the high voltage supply results in that the polymer or biopolymer is out of the outer device through the opening so as to gain the fibrils in between the central device and the outer device.

A method for manufacturing fibrils comprises the steps of: (a) providing polymer or biopolymer into a rotating device with at least one opening; (b) revolving the rotating device in order to let the polymer or biopolymer be out of the rotating device through the opening; and (c) gaining the fibrils in between the rotating device and an outer barrier.

A method for manufacturing fibrils comprises the steps of: (a) providing polymer or biopolymer into a rotating device with at least one opening; (b) revolving the rotating device and generating electrical field between the rotating device and an outer barrier around the rotating device by a high voltage supply simultaneously in order to let the polymer or biopolymer be out of the rotating device through the opening; and (c) gaining the fibrils in between the rotating device and the outer barrier.

A method for manufacturing fibrils comprises the steps of: (a) providing polymer or biopolymer with ferromagnetic substance into an outer device with at least one opening; (b) making the polymer or biopolymer be out of the outer device through the opening by magnetic forces between a central device and the polymer or biopolymer with the ferromagnetic substance; and (c) gaining the fibrils in between the outer device and the central device.

A method for manufacturing fibrils comprises the steps of: (a) providing polymer or biopolymer into an outer device with at least one opening; (b) generating electrical field between the outer device and a central device, which is around by the outer device, by a high voltage supply in order to let the polymer or biopolymer be out of the outer device through the opening; and (c) gaining the fibrils in between the outer device and the central device.

Other and further features, advantages, and benefits of the invention will become apparent in the following description taken in conjunction with the following drawings. It is to be understood that the foregoing general description and following detailed description are exemplary and explanatory but are not to be restrictive of the invention. The accompanying drawings are incorporated in and constitute a part of this application and, together with the description, serve to explain the principles of the invention in general terms. Like numerals refer to like parts throughout the disclosure.

### BRIEF DESCRIPTION OF THE DRAWINGS

The objects, spirits, and advantages of the preferred embodiments of the present invention will be readily understood by the accompanying drawings and detailed descriptions, wherein:

FIG. 1, which illustrates a schematic view of a device manufacturing fibers in prior arts;

FIG. 2A illustrates a picture of spraying the jet and splaying the jet to form the Taylor Cone;

FIG. 2B illustrates an amplified picture of the Taylor Cone;

FIG. 2C illustrates a picture of a fiber film with a diameter of 8 cm;

FIG. 2D illustrates an SEM image of the formed fibers;

FIG. 3 illustrates a schematic view of a first preferred embodiment of a spinning device of the present invention;

FIG. 4 illustrates a schematic view of a second preferred embodiment of a spinning device of the present invention;

FIG. 5 illustrates a schematic view of a third preferred embodiment of a spinning device of the present invention;

FIG. 6 illustrates a schematic view of a fourth preferred embodiment of a spinning device of the present invention;

FIG. 7 illustrates a flow chart of a first preferred embodiment of a spinning method of the present invention;

FIG. 8 illustrates a flow chart of a second preferred embodiment of a spinning method of the present invention;

FIG. 9 illustrates a flow chart of a third preferred embodiment of a spinning method of the present invention; and

FIG. 10 illustrates a flow chart of a fourth preferred embodiment of a spinning method of the present invention.

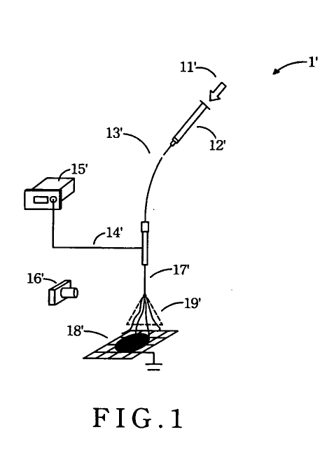

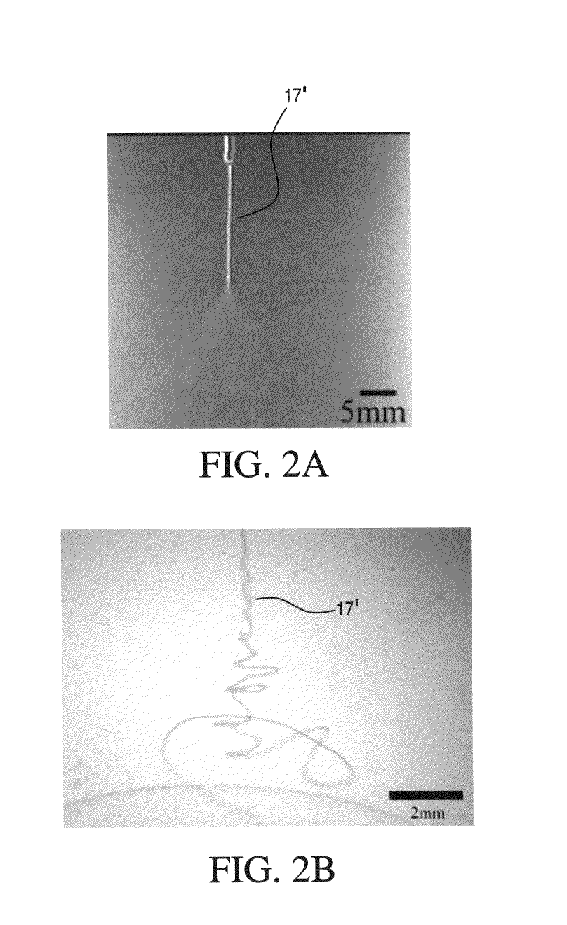

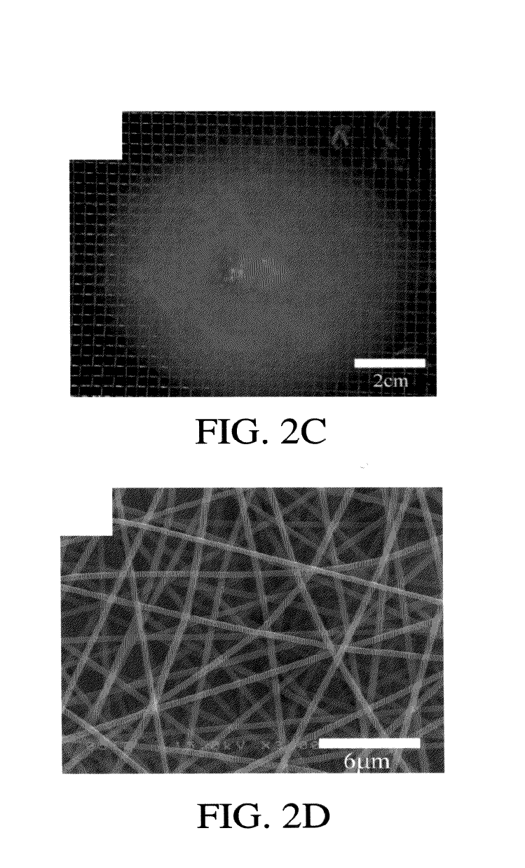

### DETAILED DESCRIPTION OF THE INVENTION

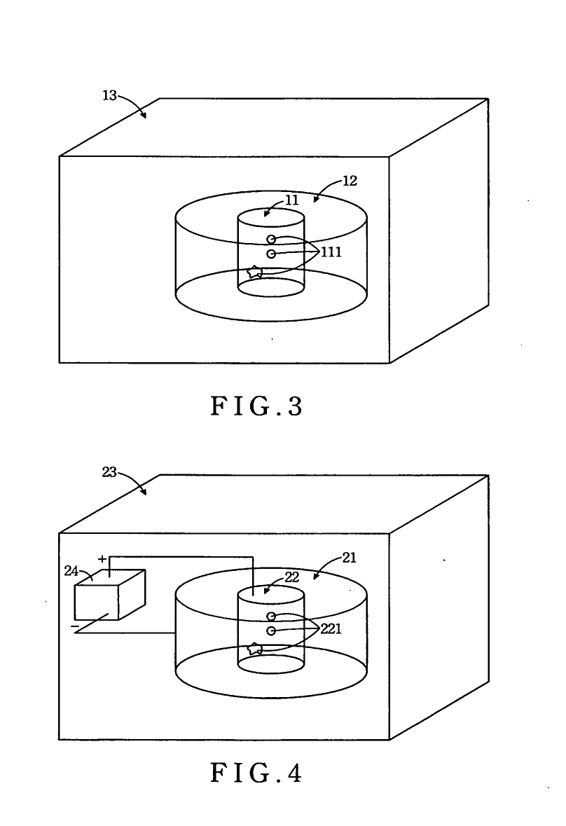

With reference to FIG. 3, which illustrates a schematic view of a first preferred embodiment of a spinning device of the present invention. A melting spinning device 1 for manufacturing fibrils comprises: a rotating device 11 with at least one opening 111, which is a hole, rift, or any of other hollow shapes, being made of an electric conduction material and hollow for containing polymer or biopolymer (not shown in figure), which is liquid or solid; an outer barrier 12 being made of electric conduction materials and around the rotating device 11; and an isolating chamber 13, which contains the rotating device 11 and the outer barrier 12 in order to control the environmental factors of vacuum, temperature controlled and specific gas, for example, but not limited to, N2, CO2, mixing specific chemical air, etc., for cross-linking different chemical materials; wherein while revolving the rotating device 11 results in that the polymer or biopolymer is out of the rotating device 11 through the opening 111 so as to gain the fibrils (not shown in figure) in between the rotating device 11 and the outer barrier 12. Further, the rotating device 11 can be heated as well.

More, the melting spinning device 1 for manufacturing fibrils further comprises an ultraviolet device, a heating device, a γ-ray device, etc., so as to cross-link different chemical materials in physical way.

With reference to FIG. 4, which illustrates a schematic view of a second preferred embodiment of a spinning device of the present invention. An electric spinning device 2 for manufacturing fibrils comprises: a rotating device 21 with at least one opening 211, which is a hole, rift, or any of other hollow shapes, being made of an electric conduction material and hollow for containing polymer or biopolymer (not shown in figure), which is liquid or solid; an outer barrier 22 being made of electric conduction materials and around the rotating device 21; an isolating chamber 23, which contains the rotating device 21 and the outer barrier 22 in order to control the environmental factors of vacuum, temperature controlled and specific gas, for example, but not limited to, N2, CO2, mixing specific chemical air, etc., for cross-linking different chemical materials; and a high voltage supply 24; wherein while revolving the rotating device 21 and electrical field being generated between the rotating device 21 and the outer barrier 22 by the high voltage supply 24 result in that the polymer or biopolymer is out of the rotating device 21 through the opening 211 so as to gain the fibrils in between the rotating device 21 and the outer barrier 22. Further, the rotating device 21 can be heated as well.

More, the electric spinning device 2 for manufacturing fibrils further comprises an ultraviolet device, a heating device, a γ-ray device, etc., so as to cross-link different chemical materials in physical way.

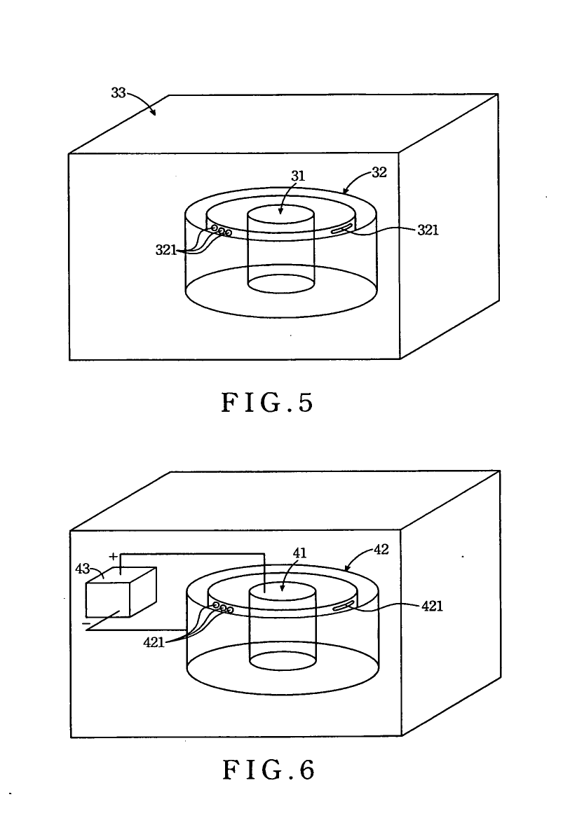

With reference to FIG. 5, which illustrates a schematic view of a third preferred embodiment of a spinning device of the present invention. A melting spinning device 3 for manufacturing fibrils comprises: a central device 31 being made of an electric conduction material; an outer device 32 with at least one opening 321, which is a hole, rift or any of other hollow shapes, being made of an electric conduction material and hollow for containing polymer or biopolymer, which is liquid or solid and includes ferromagnetic substance, the outer device 32 being around the central device 31; and an isolating chamber 33, which contains the central device 31 and the outer device 32 in order to control the environmental factors of vacuum, temperature controlled and specific gas, for example, but not limited to, N2, CO2, mixing specific chemical air, etc., for cross-linking different chemical materials; wherein while revolving the central device 31 and/or magnetic forces between the central device and the polymer or biopolymer with the ferromagnetic substance result in that the polymer or biopolymer is out of the outer device 32 through the opening 321 so as to gain the fibrils in between the central device 31 and the outer device 32. Further, the outer device 32 can be heated as well.

More, the melting spinning device 3 for manufacturing fibrils further comprises an ultraviolet device, a heating device, a γ-ray device, etc., so as to cross-link different chemical materials in physical way.

With reference to FIG. 6, which illustrates a schematic view of a fourth preferred embodiment of a spinning device of the present invention. An electric spinning device 4 for manufacturing fibrils comprises: a central device 41 being made of an electric conduction material; an outer device 42 with at least one opening 421, which is a hole, rift or any of other hollow shapes, being made of an electric conduction material and hollow for containing polymer or biopolymer, which is liquid or solid, the outer device 42 being around the central device 41; and an isolating chamber 43, which contains the central device 41 and the outer device 42 in order to control the environmental factors of vacuum, temperature controlled and specific gas, for example, but not limited to, N2, CO2, mixing specific chemical air, etc., for cross-linking different chemical materials; and a high voltage supply 44; wherein while revolving the central device 42 and/or electrical field being generated between the central device 41 and the outer device 42 by the high voltage supply results in that the polymer or biopolymer is out of the outer device 42 through the opening 421 so as to gain the fibrils in between the central device 41 and the outer device 42. Further, the outer device 42 can be heated as well.

More, the electric spinning device 4 for manufacturing fibrils further comprises an ultraviolet device, a heating device, a γ-ray device, etc., so as to cross-link different chemical materials in physical way.

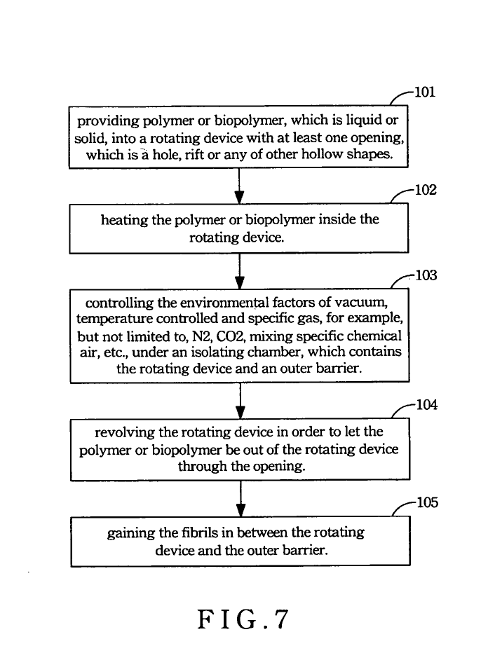

With reference to FIG. 7, which illustrates a flow chart of a first preferred embodiment of a spinning method of the present invention. A melting spinning method for manufacturing fibrils comprises the steps of (101) providing polymer or biopolymer, which is liquid or solid, into a rotating device with at least one opening, which is a hole, rift or any of other hollow shapes; (102) heating the polymer or biopolymer inside the rotating device; (103) controlling the environmental factors of vacuum, temperature controlled and specific gas, for example, but not limited to, N2, CO2, mixing specific chemical air, etc., under an isolating chamber, which contains the rotating device and an outer barrier; (104) revolving the rotating device in order to let the polymer or biopolymer be out of the rotating device through the opening; and (105) gaining the fibrils in between the rotating device and the outer barrier. Wherein step (102) or step (103) or both steps can be added into can be flexibly added into the whole steps of the method.

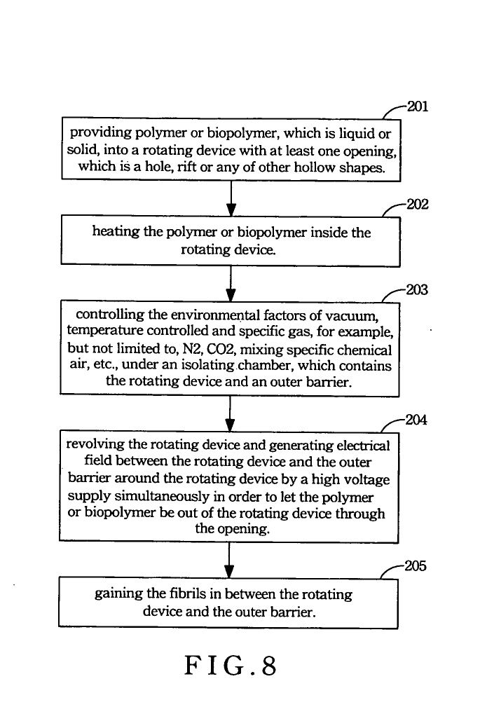

With reference to FIG. 8, which illustrates a flow chart of a second preferred embodiment of a spinning method of the present invention. An electrical spinning method for manufacturing fibrils comprises the steps of (201) providing polymer or biopolymer, which is liquid or solid, into a rotating device with at least one opening, which is a hole, rift or any of other hollow shapes; (202) heating the polymer or biopolymer inside the rotating device; (203) controlling the environmental factors of vacuum, temperature controlled and specific gas, for example, but not limited to, N2, CO2, mixing specific chemical air, etc., under an isolating chamber, which contains the rotating device and an outer barrier; (204) revolving the rotating device and generating electrical field between the rotating device and the outer barrier around the rotating device by a high voltage supply simultaneously in order to let the polymer or biopolymer be out of the rotating device through the opening; and (205) gaining the fibrils in between the rotating device and the outer barrier. Wherein step (202) or step (203) or both steps can be flexibly added into can be added into the whole steps of the method.

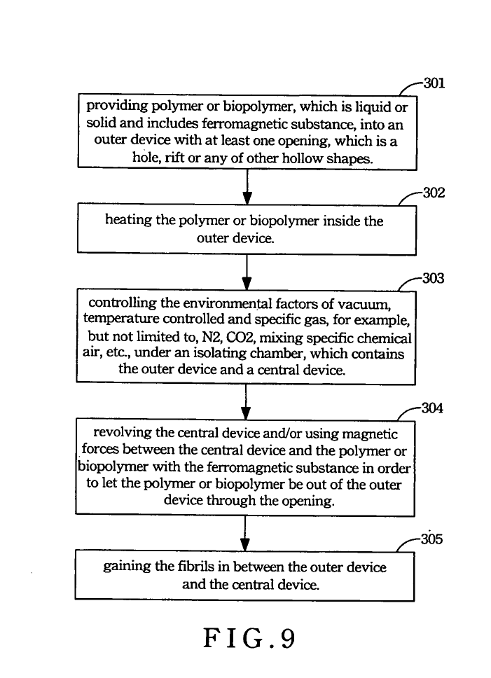

With reference to FIG. 9, which illustrates a flow chart of a third preferred embodiment of a spinning method of the present invention. A melting spinning method for manufacturing fibrils comprises the steps of: (301) providing polymer or biopolymer, which is liquid or solid and includes ferromagnetic substance, into an outer device with at least one opening, which is a hole, rift or any of other hollow shapes; (302) heating the polymer or biopolymer inside the outer device; (303) controlling the environmental factors of vacuum, temperature controlled and specific gas, for example, but not limited to, N2, CO2, mixing specific chemical air, etc., under an isolating chamber, which contains the outer device and a central device; (304) revolving the central device and/or using magnetic forces between the central device and the polymer or biopolymer with the ferromagnetic substance in order to let the polymer or biopolymer be out of the outer device through the opening; and (305) gaining the fibrils in between the outer device and the central device. Wherein step (302) or step (303) or both steps can be flexibly added into the whole steps of the method.

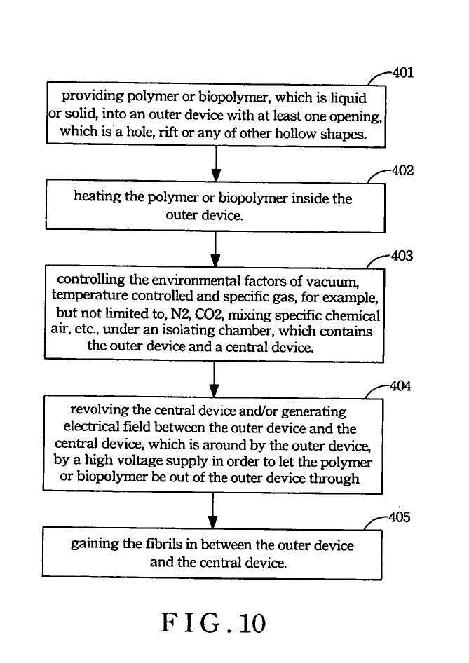

With reference to FIG. 10, which illustrates a flow chart of a fourth preferred embodiment of a spinning method of the present invention. An electrical spinning method for manufacturing fibrils comprises the steps of: (401) providing polymer or biopolymer, which is liquid or solid, into an outer device with at least one opening, which is a hole, rift or any of other hollow shapes; (402) heating the polymer or biopolymer inside the outer device; (403) controlling the environmental factors of vacuum, temperature controlled and specific gas, for example, but not limited to, N2, CO2, mixing specific chemical air, etc., under an isolating chamber, which contains the outer device and a central device; (404) revolving the central device and/or generating electrical field between the outer device and the central device, which is around by the outer device, by a high voltage supply in order to let the polymer or biopolymer be out of the outer device through the opening; and (405) gaining the fibrils in between the outer device and the central device. Wherein step (402) or step (403) or both steps can be flexibly added into the whole steps of the method.

It has now been found that the components in textile fiber or matrices of smaller diameter provide water absorbent, water repellent and tissue engineering application, such as cell induction. For this invention, we established a device with rotating center and an outer barrier to document the products. From the concept of this invention, two spinning devices are applied, that is, melting spinning device and electrospinning device with electrical field. The materials could be biocompatible for the purpose of biomaterials, or other textile materials for the industrial use or else. Finally, the specific shape of rift or holes on the rotating device or the outer device can be modified to increase the application, such as polygon base of fiber or hollow fiber. Fibrous, fibril organic and inorganic materials of smaller diameter can be integrated into nonwoven three-dimensional matrices conducive for cell seeding, proliferation, and water channel. These three-dimensional scaffolds or matrices can then be fabricated into appropriate shapes to simulate the hierarchical micro- and macro-geometry of tissues and/or organs to be repaired or replaced.

Many of the applications for these structures including, but not limited to, medical devices and chemical separation and/or protection apparatus require broad ranges of fiber architecture, packing density, surface texture, porosity, total reactive surface areas and fiber. Accordingly, it would be of great advantage in the art in many of these uses, if fibers of smaller diameter with greater strength could be prepared. For the tissue engineering application, the limitations have initiated the search for a dependable biomaterials substitute. However, in order for an implant to be used as a scaffold for tissue engineering, it must be capable of both cell integration and cell conduction. Cell integration refers to direct chemical bonding of a biomaterial to the surface of tissue without any strong immune reaction. This bonding is referred as the implant-tissue interface. Cell conduction refers to the ability of a biomaterial to sustain cell growth and proliferation over its surface while maintaining the cellular phenotype. Normal tissue engineering function is particularly important for porous implants that require cell in-growth for proper strength and adequate surface area for tissue bonding. In addition, implants should be biocompatible.

It has now been found, however, that tissue engineered devices with enhanced properties of cell adhesion, cell proliferation and directional growth can be prepared from matrices comprising biocompatible fibers of a diameter which is an order of magnitude smaller than the cells. Accordingly, the present invention relates to fibers of smaller diameter, referred to herein as fibrils, with adequate strength for use in textile processing processes and methods of producing these fibrils. Tissue engineering devices are also provided which are prepared from scaffolds or matrices comprising fibrils.

As a result of advances in cross technology development in recent years, textile technology with tissue engineering application is becoming a method of choice for the development of scaffold. In this invention, we create an embodiment, which can not only be use in textile production but also in biomaterials production. There are several innovations in this system. First, we create a rotating center with one single or several specific shapes of rift or holes on the surface which can obtain polymer or biopolymer inside. Second, the electrical field can be created by different charge between rotating center and outer line. The electrical force inside the electrical field will drive the polymer or biopolymer to the outer line to produce fibers. Third, the whole system can be easily added some optional device to create more application, such as UV light, temperature controlled, vacuum controlled, freeze drying, etc. Further more; we can change the specific shape of rift or holes on the surface of rotating center to create an optimal fiber shape, for example, if the polygonal like shape of rifts or holes will produce non round shaped fiber.

Further, it has now been demonstrated that the fibrils of smaller diameter of the present invention in various selected architectures enhance interaction of the scaffold or matrix with cells. By “enhanced” it is meant that the scaffold or matrix is prepared from fibrils of smaller diameter in a configuration or architecture which optimizes interactions between the scaffold or matrix and cells which are required for the intended purpose of the matrix. Examples of fibril materials which can be used in this embodiment the present invention include, but are not limited to, non-degradable polymers such as polyethylenes and polyurethanes and degradable polymers such as poly (lactic acid-glycolic acid), poly (lactic acid), poly(glycolic acid), poly (glaxanone), poly (orthoesters), poly (pyrolicacid) and poly (phosphazenes). Other components which can be incorporated into the matrices include, but are not limited to, calcium phosphate based ceramics such as hydroxyapatite and tricalcium phosphate.

Although this invention has been disclosed and illustrated with reference to particular embodiments, the principles involved are susceptible for use in numerous other embodiments that will be apparent to persons skilled in the art. This invention is, therefore, to be limited only as indicated by the scope of the appended claims.

What is claimed is:

1. A device for manufacturing fibrils comprising:
a rotating device with at least one opening being made of an electric conduction material and hollow for containing polymer or biopolymer; and
an outer barrier being made of electric conduction materials and around the rotating device;
wherein while revolving the rotating device results in that the polymer or biopolymer is out of the rotating device through the opening so as to gain the fibrils in between the rotating device and the outer barrier.

2. The device for manufacturing fibrils according to claim 1, wherein the state of the polymer or biopolymer is selected from the group of: liquid and solid.

3. The device for manufacturing fibrils according to claim 1, wherein the opening is selected from the group of: hole and rift.

4. The device for manufacturing fibrils according to claim 1 further comprising an isolating chamber, which contains the rotating device and the outer barrier in order to control the whole or any of environmental factors of the group of: vacuum, temperature controlled, gas, and different cross-linkers.

5. The device for manufacturing fibrils according to claim 4 further comprising the whole or any of the group of: an ultraviolet device, a heating device and a γ-ray device so as to cross-link different chemical materials in physical way.

6. A device for manufacturing fibrils comprising:
a rotating device with at least one opening being made of an electric conduction material and hollow for containing polymer or biopolymer;
an outer barrier being made of electric conduction materials and around the rotating device; and
a high voltage supply;
wherein while revolving the rotating device and electrical field being generated between the rotating device and the outer barrier by the high voltage supply result in that the polymer or biopolymer is out of the rotating device through the opening so as to gain the fibrils in between the rotating device and the outer barrier.

7. The device for manufacturing fibrils according to claim 6, wherein the state of the polymer or biopolymer is selected from the group of: liquid and solid.

8. The device for manufacturing fibrils according to claim 6, wherein the opening is selected from the group of: hole and rift.

9. The device for manufacturing fibrils according to claim 6 further comprising an isolating chamber, which contains the rotating device and the outer barrier in order to control the whole or any of environmental factors of the group of: vacuum, temperature controlled, gas, and different cross-linkers.

10. The device for manufacturing fibrils according to claim 9 further comprising the whole or any of the group of: an ultraviolet device, a heating device and a γ-ray device so as to cross-link different chemical materials in physical way.

11. A device for manufacturing fibrils comprising:
a central device being made of an electric conduction material; and
an outer device with at least one opening being made of an electric conduction material and hollow for containing polymer or biopolymer, which includes ferromagnetic substance, the outer device being around the central device;
wherein the polymer or biopolymer can be out of the outer device through the opening by magnetic forces between the central device and the polymer or biopolymer with the ferromagnetic substance so as to gain the fibrils in between the central device and the outer device.

12. The device for manufacturing fibrils according to claim 11, wherein the state of the polymer or biopolymer is selected from the group of: liquid and solid.

13. The device for manufacturing fibrils according to claim 11, wherein the opening is selected from the group of: hole and rift.

14. The device for manufacturing fibrils according to claim 11 further comprising an isolating chamber, which contains the central device and the outer device in order to control the whole or any of environmental factors of the group of: vacuum, temperature controlled, gas, and different cross-linkers.

15. The device for manufacturing fibrils according to claim 14 further comprising the whole or any of the group of: an ultraviolet device, a heating device and a γ-ray device so as to cross-link different chemical materials in physical way.

16. The device for manufacturing fibrils according to claim 11, wherein revolving the central device results in that the polymer or biopolymer is out of the outer device through the opening so as to gain the fibrils in between the central device and the outer device.

17. A device for manufacturing fibrils comprising:
a central device being made of an electric conduction material;
an outer device with at least one opening being made of an electric conduction material and hollow for containing polymer or biopolymer, the outer device being around the central device; and
a high voltage supply;
wherein electrical field being generated between the central device and the outer device by the high voltage supply results in that the polymer or biopolymer is out of the outer device through the opening so as to gain the fibrils in between the central device and the outer device.

18. The device for manufacturing fibrils according to claim 17, wherein the state of the polymer or biopolymer is selected from the group of: liquid and solid, and the polymer or biopolymer includes ferromagnetic substance.

19. The device for manufacturing fibrils according to claim 17, wherein the opening is selected from the group of: hole and rift.

20. The device for manufacturing fibrils according to claim 17 further comprising an isolating chamber, which contains the central device and the outer device in order to control the whole or any of environmental factors of the group of: vacuum, temperature controlled, gas, and different cross-linkers.

21. The device for manufacturing fibrils according to claim 20 further comprising the whole or any of the group of: an ultraviolet device, a heating device and a γ-ray device so as to cross-link different chemical materials in physical way.

22. The device for manufacturing fibrils according to claim 17, wherein revolving the central device results in that the polymer or biopolymer is out of the outer device through the opening so as to gain the fibrils in between the central device and the outer device.

23. A method for manufacturing fibrils comprising the steps of:
(a) providing polymer or biopolymer into a rotating device with at least one opening;
(b) revolving the rotating device in order to let the polymer or biopolymer be out of the rotating device through the opening; and
(c) gaining the fibrils in between the rotating device and an outer barrier.

24. The method for manufacturing fibrils according to claim 23, wherein step (a′) can be added between step (a) and step (b) and is of:
heating the polymer or biopolymer inside the rotating device.

25. The method for manufacturing fibrils according to claim 23, wherein the state of the polymer or biopolymer is selected from the group of: liquid and solid.

26. The method for manufacturing fibrils according to claim 23, wherein the opening is selected from the group of: hole and rift.

27. The method for manufacturing fibrils according to claim 23, wherein step (a″) can be added between step (a) and step (b) and is of:
controlling the whole or any of environmental factors of the group of vacuum, temperature controlled, gas, and different cross-linkers, under an isolating chamber, which contains the rotating device and the outer barrier.

28. A method for manufacturing fibrils comprising the steps of:
(a) providing polymer or biopolymer into a rotating device with at least one opening;
(b) revolving the rotating device and generating electrical field between the rotating device and an outer barrier around the rotating device by a high voltage supply simultaneously in order to let the polymer or biopolymer be out of the rotating device through the opening; and
(c) gaining the fibrils in between the rotating device and the outer barrier.

29. The method for manufacturing fibrils according to claim 28, wherein step (a′) can be added between step (a) and step (b) and is of:
heating the polymer or biopolymer inside the rotating device.

30. The method for manufacturing fibrils according to claim 28, wherein the state of the polymer or biopolymer is selected from the group of: liquid and solid.

31. The method for manufacturing fibrils according to claim 28, wherein the opening is selected from the group of: hole and rift.

32. The method for manufacturing fibrils according to claim 28, wherein step (a″) can be added between step (a) and step (b) and is of:
controlling the whole or any of environmental factors of the group of vacuum, temperature controlled, gas, and different cross-linkers, under an isolating chamber, which contains the rotating device and the outer barrier.

33. A method for manufacturing fibrils comprising the steps of:
(a) providing polymer or biopolymer with ferromagnetic substance into an outer device with at least one opening;
(b) making the polymer or biopolymer be out of the outer device through the opening by magnetic forces between a central device and the polymer or biopolymer with the ferromagnetic substance; and
(c) gaining the fibrils in between the outer device and the central device.

34. The method for manufacturing fibrils according to claim 33, wherein step (a′) can be added between step (a) and step (b) and is of:
heating the polymer or biopolymer inside the outer device.

35. The method for manufacturing fibrils according to claim 33, wherein the state of the polymer or biopolymer is selected from the group of: liquid and solid.

36. The method for manufacturing fibrils according to claim 33, wherein the opening is selected from the group of: hole and rift.

37. The method for manufacturing fibrils according to claim 33, wherein step (a″) can be added between step (a) and step (b) and is of:
controlling the whole or any of environmental factors of the group of vacuum, temperature controlled, gas, and different cross-linkers, under an isolating chamber, which contains the outer device and the central device.

38. The method for manufacturing fibrils according to claim 33, wherein step (b′) can be added in step (b) and is of:
revolving the central device in order to let the polymer or biopolymer be out of the outer device through the opening.

39. A method for manufacturing fibrils comprising the steps of:
(a) providing polymer or biopolymer into an outer device with at least one opening;
(b) generating electrical field between the outer device and a central device, which is around by the outer device, by a high voltage supply in order to let the polymer or biopolymer be out of the outer device through the opening; and
(c) gaining the fibrils in between the outer device and the central device.

40. The method for manufacturing fibrils according to claim 39, wherein step (a′) can be added between step (a) and step (b) and is of:
heating the polymer or biopolymer inside the outer device.

41. The method for manufacturing fibrils according to claim 39, wherein the state of the polymer or biopolymer is selected from the group of: liquid and solid.

42. The method for manufacturing fibrils according to claim 39, wherein the opening is selected from the group of: hole and rift.

43. The method for manufacturing fibrils according to claim 39, wherein step (a″) can be added between step (a) and step (b) and is of:
controlling the whole or any of environmental factors of the group of vacuum, temperature controlled, gas, and different cross-linkers, under an isolating chamber, which contains the outer device and the central device.

44. The method for manufacturing fibrils according to claim 39, wherein step (b″) can be added in step (b) and is of:
revolving the central device in order to let the polymer or biopolymer be out of the outer device through the opening.
